(19) United States
(12) Patent Application Publication
(10) Pub. No.: US 2006/0223591 A1
(43) Pub. Date: Oct. 5, 2006

(54) Communications device and method for automatically answering an incoming call

(76) Inventors: Guo Chen Wang, HaiDian District (CN); Jin Quan Lu, HaiDian District (CN); Gang Nie, Shan District (CN)

Correspondence Address: MOTOROLA INC, 600 NORTH US HIGHWAY 45, ROOM AS437, LIBERTYVILLE, IL, 60048-5343, US

(21) Appl. No.: 11/387,311

(22) Filed: Mar. 23, 2006

(30) Foreign Application Priority Data
Apr. 5, 2005 (CN) 200510062692.3

(51) Int. Cl. H04B 1/38; H04M 1/00

(52) U.S. Cl. 455/567

(57) ABSTRACT

A communications device (100) and method (300) for selectively answering an incoming call received by the communications device (100). The method (100) provides an alert signal (330) in response to receiving; the incoming call (310) and then provides for automatically answering the incoming call (360) when the device detects (355) a change in state from an inoperative coupling state to an operative coupling state between the device (100) and an earpiece and microphone accessory (210).

### FIELD OF THE INVENTION

The present invention relates generally to a communications device and method for automatically answering an incoming call when an accessory is operatively coupled to the device.

### BACKGROUND

Portable handheld electronic devices such as handheld wireless communications devices (e.g. cellphones) that are easy to transport are becoming commonplace. Such handheld electronic devices come in a variety of different form factors and support many features and functions.

On many occasions when an incoming call is received by a wireless communications device, and an alert is provided to inform a user of the call, the user may require to couple an earpiece and microphone accessory to the device before answering the call. However, the user's vision and hands may sometimes pre-occupied to some extent with a task other than answering the call. If the user still wishes to answer the call, and use the earpiece and microphone accessory, then user may be distracted by firstly inserting the accessory into a port of the device and then identifying and actuating an “answer call” button (or Key). As a result, then user may be dissuaded from answering the call.

### SUMMARY OF THE INVENTION

According to one aspect of the invention there is provided a communications device comprising:

A processor;

An alert module coupled to the processor;

A communications unit coupled to the processor;

An accessory port coupled to the processor, the port providing an inoperative coupling state and an operative coupling state with an earpiece and microphone accessory; and

A sensor associated with the port,
Wherein, upon the alert module providing an alert signal in response to the communications unit receiving an incoming call, the processor automatically controls the communications module to answer the call when the sensor detects a change in state from the inoperative coupling state to the operative coupling state of the accessory to the port.

Suitably, in use, the sensor detects the change when the accessory is inserted into the port.

An integral speaker and microphone of the device are suitably switched to an inoperable condition when the sensor module detects a change in the state from the inoperative coupling state to the operative coupling state of the accessory to the port. .

Suitably, in use, the processor controls the communications unit to automatically end the call when the sensor detects a change in the state from the operative coupling state to the inoperative coupling state of the accessory to the port.

According to another aspect of the invention there is provided a method for selectively answering an incoming call received by a communications device, the method comprising:

Receiving the incoming call;

Providing an alert signal in response to the receiving; and

Automatically answering the incoming call when the device detects a change in state from an inoperative coupling state to an operative coupling state between the device and an earpiece and microphone accessory.

Suitably, the method further includes automatically ending the call when the when the device detects a change in the state from the operative coupling state to an inoperative coupling state between the device and the earpiece and microphone accessory.

### BRIEF DESCRIPTION OF THE FIGURES

In order that the invention may be readily understood and put into practical effect, reference will now be made to an exemplary embodiment as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a block diagram of a communications device in accordance with an embodiment of the invention;

FIG. 2 is an example of an accessory port and sensor of the communications device of FIG. 1 and an associated accessory; and

FIG. 3 is a flow diagram illustrating a method for selectively answering an incoming call received by the communications device of FIG. 1 in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail an embodiment that is in accordance with the present invention, it should be observed that the embodiment resides primarily in combinations of method steps and apparatus components related to a communications device and method for selectively answering an incoming call. Accordingly, the device components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, the terms “comprises,” “comprising,” or any other variation thereof, are intended to cover a non-exclusive inclusion, such that a method or device that comprises a list of elements does not include only those elements but may include other elements not expressly listed or inherent to such methods or devices. An element proceeded by “comprises . . . a” does not, without more constraints, preclude the existence of additional identical elements in the method or device that comprises the element.

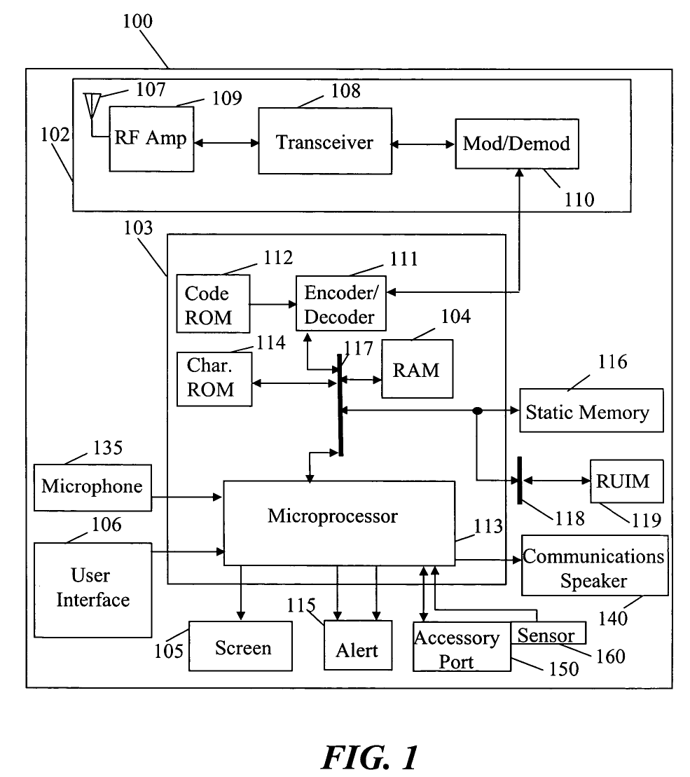

Referring to FIG. 1, there is a schematic diagram illustrating a communications device 100, typically a wireless communications device, in the form of a mobile station or mobile telephone comprising a radio frequency communications unit 102 coupled to be in communication with a processor 103. The communications device 100 also has a screen 105, a user interface 106, an accessory port 150 and an associated sensor 160. There is also an alert module 115 that typically contains an alert speaker, vibrator motor and associated drivers. The screen 105, user interface 106, accessory port 150, alert module 115 and sensor 160 are coupled to be in communication with the processor 103. In one embodiment, the screen 105 or an area thereof may be in the form of a touch screen.

The processor 103 includes an encoder/decoder 111 with an associated code Read Only Memory (ROM) 112 for storing data for encoding and decoding voice or other signals that may be transmitted or received by the communications device 100. The processor 103 also includes a micro-processor 113 coupled, by a common data and address bus 117, to the encoder/decoder 111, a character Read Only Memory (ROM) 114, a Random Access Memory (RAM) 104, static programmable memory 116 and a Removable User Identity Module (RUIM) interface 118. The static programmable memory 116 and a RUIM card 119 (commonly referred to as a Subscriber Identity Module (SIM) card) operatively coupled to the RUIM interface 118 each can store, amongst other things, Preferred Roaming Lists (PRLs), subscriber authentication data, selected incoming text messages and a Telephone Number Database (TND phonebook) comprising a number field for telephone numbers and a name field for identifiers associated with one of the numbers in the name field. The RUIM card 119 and static memory 116 may also store passwords for allowing accessibility to password-protected functions on the mobile telephone 100.

The micro-processor 113 has ports for coupling to the user interface 106, the accessory port 150, the sensor 160, screen 105 and an alert 115. Also, micro-processor 113 has ports for coupling to an integral microphone 135 and an integral communications speaker 140 that are integral with the device.

The character Read Only Memory 114 stores code for decoding or encoding text messages that may be received by the communications unit 102. In this embodiment the character Read Only Memory 114, RUIM card 119, and static memory 116 may also store Operating Code (OC) for the micro-processor 113 and code for performing functions associated with the mobile telephone 100.

The radio frequency communications unit 102 is a combined receiver and transmitter having a common antenna 107. The communications unit 102 has a transceiver 108 coupled to the antenna 107 via a radio frequency amplifier 109. The transceiver 108 is also coupled to a combined modulator/demodulator 110 that couples the communications unit 102 to the processor 103.

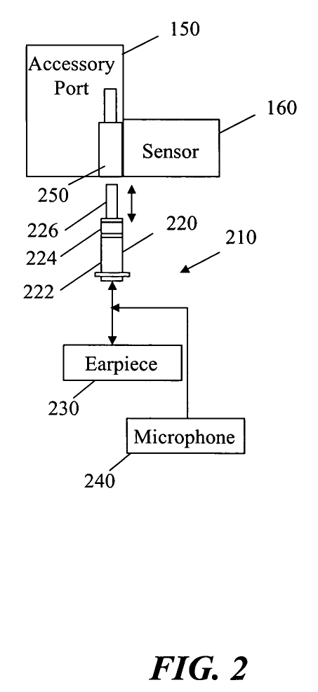

Referring to FIG. 2 there is illustrated example of the accessory port 150, sensor 160 and an associated earpiece and microphone accessory 210. The accessory 210 comprises Jack-plug 220 with plug connectors 222, 224 coupled by wiring to an earpiece 230 and plug connectors 222, 226 coupled by wiring to a microphone 240. The accessory port 150 has a Jack-socket 250 with connectors (not illustrated) for operatively engaging and coupling with the plug connectors 222, 224, 226. Also, the sensor is typically adjacent the Jack-socket 250 and comprises a sensing switch for detecting an operative coupling state OCS between the device 100 and the earpiece and microphone accessory 210 and an inoperative coupling state ICS between the device 100 and the earpiece and microphone accessory 210. Hence, the sensor 160 provides an accessory coupling signal ACS having two states, one state being indicative of the operative coupling state OCS and the other state being indicative of the inoperative coupling state ICS.

Often the accessory 210 is called a headset and as will be apparent to a person skilled in the art the accessory and accessory port 150 could have wireless capabilities and thus be selectively wireless coupled to each other. Thus the sensor 160 would be formed primarily from software that determines whether or not there is a wireless communications link establishing the operative coupling.

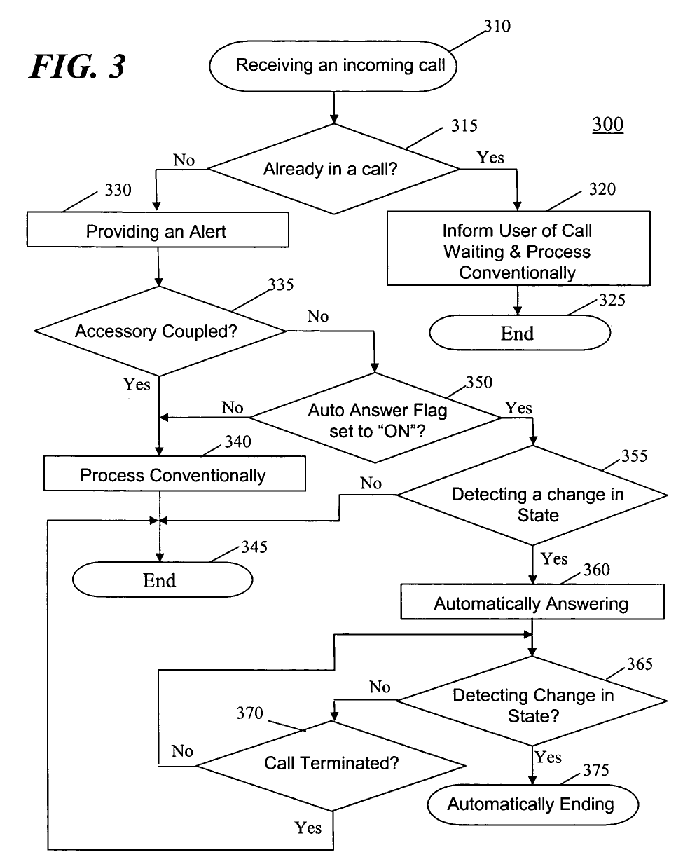

Referring to FIG. 3 there is illustrated a method 300 for selectively answering an incoming call received by the communications device 100. The method 300 is invoked when the communications unit 102 of the device 100 receives an incoming call and thus the method 300 includes and performs a receiving an incoming call at a block 310. Next, a test 315 is conducted, to determine if the device 100 is already in a call. If the device is already in a call then the device 100, at a block 320, informs a user that a call is waiting to be answered and the call is processed conventionally by a procedure well known to these skilled in the art. Thereafter, the method terminates at an end block 325.

If the test at block 315 determines that the device 100 is not already in a call then the device 100 performs a providing an alert at block 330. The providing an alert at block 330 provides an alert signal in response to the receiving of the incoming call, the alert signal is generated by the alert module 115 and informs the user of the incoming call.

Next, the method 300 performs a test 335 to determine if an accessory, such as the accessory 210, is coupled to the device 100 at the port 150. This test 335 is performed by analyzing_the accessory coupling signal ACS provided by the sensor 160 . If the accessory is coupled to the device 100 then the incoming call is processed conventionally at a block 340 and the method 300 terminates at an end block 345. Alternatively, if at test 335, it is determined that there is no accessory coupled to the port 150 of the device 100 then an auto answer test is conducted by a test 350 to determine if an auto answer flag is set to “ON”. This auto answer flag is set prior to the user receiving the incoming call, typically the auto answer flag is set to “ON” or “OFF” as a user preference in a menu selection of preferences available to a user. Other preferences that are typically available in the menu are alert signal style (e.g. ring tone selection), alert signal volume, screensaver selection, password protection settings etc.

If the test 350 determines that the auto answer flag is not set to “ON” (therefore it is set to “OFF”) then the incoming call is processed conventionally at block 340 and the method 300 terminates at the end block 345. Alternatively, if the test 350 to determines that the auto answer flag is not set to “ON” then the method 300 performs a detecting a change in state test 355. The test 355 continuously performs detecting a change in state of the of the accessory coupling signal ACS provided by the sensor 160 . If no change in state is detected then the call will eventually be rejected and unanswered (by for example the caller hanging up) and the method terminates at the end step 345. It should be noted, and as will be apparent to a person skilled in the art, the incoming call can be answered by actuation of an answer key forming the part of the user interface 106 at essentially most of the blocks 330 to 355 of the method 300.

If the device 100 at test 335 detects a change in state from the accessory coupling signal ACS provided by the sensor 160 then the method performs automatically answering the incoming call at a block 360. The automatically answering the incoming call is therefore effected when the device 100 detects a change in state from the inoperative coupling state ICS to the operative coupling state OCS between the device 100 and an earpiece and microphone accessory 210.

Thereafter, a detecting change in state test 365 is continuously performs and provides for detecting a change in state of the accessory coupling signal ACS provided by the sensor 160. If no change in state is detected then the call will be maintained until it is terminated at end block 345 by a party who initially called the device 100 or by accidental or intentional network connection termination or by “end call” key forming the part of the user interface 106 is actuated as detected at a call terminated test 370. However, if a change in state is detected at test 365 then the method 300 performs automatically ending the call at a block 375. The automatically ending the call is therefore effected when the when the device 100 detects a change in the state from the operative coupling state OCS to the inoperative coupling state ICS between the device 100 and the earpiece and microphone accessory 210.

As can be seen from the method 300, upon the alert module 115 proving at block 330, the alert signal in response to the communications unit 102 receiving the incoming call, the processor 103 automatically controls the communications module 102 to answer the call when the sensor 160 detects a change in state from the inoperative coupling state ICS to the operative coupling state OCS of the accessory to the port. The sensor 160 in the exemplary embodiment detects the change when the accessory 210 is inserted into the port 150. The integral speaker 140 and microphone 135 are switched to an inoperable condition when the sensor module 160, at the detecting a change in state test 355, detects a change in the state from the inoperative coupling state ICS to the operative coupling state OCS. Also, the processor 103 controls the communications unit 102, to automatically end the call at a block 375. This occurs when the sensor 160 detects a change in the state from the operative coupling state OCS to the inoperative coupling state IOC at test 365.

Advantageously, the present invention provides for automatically answering or ending an incoming call by respectively coupling and uncoupling the earpiece and microphone accessory 210 from the device 100. As a result, there is no need to for a user to identify and actuate either the “answer call” button (or Key) or “end call” button (or Key) in addition to either inserting or removing the accessory Jack-plug from the device 100.

It will be appreciated that embodiments of the invention described herein may be comprised of one or more conventional processors and unique stored program instructions that control the one or more processors to implement, in conjunction with certain non-processor circuits, some, most, or all of the functions of the device 100 described herein. As such, these functions may be interpreted as steps of the method 300 to perform automatically answering the incoming call. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and devices for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims.

We claim:

1. A communications device comprising:
A processor;
An alert module coupled to the processor;
A communications unit coupled to the processor;
An accessory port coupled to the processor, the port providing an inoperative coupling state and an operative coupling state with an earpiece and microphone accessory; and
A sensor associated with the port,
Wherein, upon the alert module providing an alert signal in response to the communications unit receiving an incoming call, the processor automatically controls the communications module to answer the call when the sensor detects a change in state from the inoperative coupling state to the operative coupling state of the accessory to the port.

2. A communications device as claimed in claim 1, wherein, in use, the sensor detects the change when the accessory is inserted into the port.

3. A communications device as claimed in claim 1, wherein an integral speaker and microphone of the device are suitably switched to an inoperable condition when the sensor module detects a change in the state from the inoperative coupling state to the operative coupling state of the accessory to the port. .

4. A communications device as claimed in claim 1, wherein, in use, the processor controls the communications unit to automatically end the call when the sensor detects a change in the state from the operative coupling state to the inoperative coupling state of the accessory to the port.

5. A method for selectively answering an incoming call received by a communications device, the method comprising:
Receiving the incoming call;
Providing an alert signal in response to the receiving; and
Automatically answering the incoming call when the device detects a change in state from an inoperative coupling state to an operative coupling state between the device and an earpiece and microphone accessory.

6. A method for selectively answering an incoming call as claimed in claim 5, wherein the method further includes automatically ending the call when the when the device detects a change in the state from the operative coupling state to an inoperative coupling state between the device and the earpiece and microphone accessory.
